(19) United States
(12) Patent Application Publication
(10) Pub. No.: US 2005/0072318 A1
(43) Pub. Date: Apr. 7, 2005

(54) Multiple layer food manufacturing apparatus

(76) Inventor: Robert Ou-Young, Taipei Hsien (TW)

Correspondence Address: ROBERT OU-YOUNG, 235 CHUNG-HO BOX 8-24, TAIPEI HSIEN, 235, TW

(21) Appl. No.: 10/705,373

(22) Filed: Nov. 12, 2003

(30) Foreign Application Priority Data
Oct. 2, 2003 (TW) 092127279

(51) Int. Cl. A23P 1/00

(52) U.S. Cl. 99/450.1

(57) ABSTRACT

A multiple layer food manufacturing apparatus comprises a combining nozzle, a right feeding device, a left feeding device, and a cutter. The outer layer food material is inputted to an outer layer channel from the right feeding device. The middle layer food material is inputted to an inner layer channel from the left feeding device. The inner layer food material is inputted to an inner tube of the combining nozzle so that the combining nozzle outputs the inner, middle and outer layer food material from a small, a middle and a outer outlet so form as a cylindrical food. The cylindrical food passes through a cutter to be cut as a ball-like food. In the processing process in the combining nozzle, the middle and outer layer food material are agitated effectively.

### FIELD OF THE INVENTION

The present invention relates to food manufacturing apparatuss, and particularly to a multiple layer food manufacturing apparatus which can form a ball-like food having three layers.

### BACKGROUND OF THE INVENTION

The prior art, stuffing forming machine, such as that manufactured by Rheon Automatic Machinery Co., Ltd., has a horizontal vane pump for changing the direction of dough to a combining nozzle. Then the combining nozzle can output a cylindrical food having two layers. The defect of this prior art is that the horizontal vane pump has a completed structure and can not effectively agitate and transfer the dough in the transfer process along the longitudinal direction. Especially, the combining nozzle only forms a cylindrical food of two layers and thus the final ball-like food has only two layers. Other prior arts have the same defects as above mentioned prior art, that is, a plurality of vane pumps are used and thus the structure is more complicated and cost is high. The dough cannot be effectively used. Moreover, they only make cylindrical foods of two layers.

### SUMMARY OF THE INVENTION

Accordingly, the primary object of the present invention is to provide a multiple layer food manufacturing apparatus, wherein the outer layer food material and middle layer food material are agitated longitudinally so that the food materials can be guided and inputted to the combining nozzle.

Another object of the present invention is to provide a multiple layer food manufacturing apparatus, wherein three layer cylindrical foods can be made.

A further object of the present invention is to provide a multiple layer food manufacturing apparatus, wherein a ball-like food of three layers are made according to the present invention.

To achieve above object, the present invention provides a multiple layer food manufacturing apparatus which comprises a combining nozzle, a right feeding device, a left feeding device, and a cutter. The outer layer food material is inputted to an outer layer channel from the right feeding device. The middle layer food material is inputted to an inner layer channel from the left-feeding device. The inner layer food material is inputted to an inner tube of the combining nozzle so that the combining nozzle outputs the inner, middle and outer layer food material from a small, a middle and a outer outlet so form as a cylindrical food. The cylindrical food passes through a cutter to be cut as a ball-like food. In the processing process, in the combining nozzle, the middle and outer layer food material are agitated effectively.

The various objects and advantages of the present invention will be more readily understood from the following detailed description when read in conjunction with the appended drawing.

### BRIEF DESCRIPTION OF THE DRAWINGS

FIG. 1 is a front view of the present invention.

FIG. 2 is a front and-partial cross section view of the present invention.

FIG. 3 is a longitudinal cross section view showing the combining nozzle and right and left feeding devices of the present invention.

FIG. 4 is a cross section view along line I-I of FIG. 3.

FIG. 5 is a transversal cross section view showing the combining nozzle and right and left feeding devices of the present invention.

FIG. 6 is an exploded perspective view of the roller and protruding plates of the present invention.

FIG. 7 is a first cross section view showing that the roller being operated in the collector.

FIG. 8 is a second cross section view showing that the roller being operated in the collector.

FIG. 9 is a third cross section view showing that the roller being operated in the collector.

FIG. 10 is a first cross section view showing the operation of the cutter of the present invention.

FIG. 11 is a second cross section view showing the operation of the cutter of the present invention.

FIG. 12 is an exploded perspective view of the cutter of the present invention.

FIG. 13 is a perspective view showing the arm of the present invention.

FIG. 14 is a cross section view showing that the inner layer food material, middle layer food material and outer layer food material of the present invention is formed as a round food.

FIG. 15 is a schematic view showing the guiding of the inner layer food material, middle layer food material and outer layer food material according to the present invention.

### DETAILED DESCRIPTION OF THE PREFERRED EMBODIMENTS

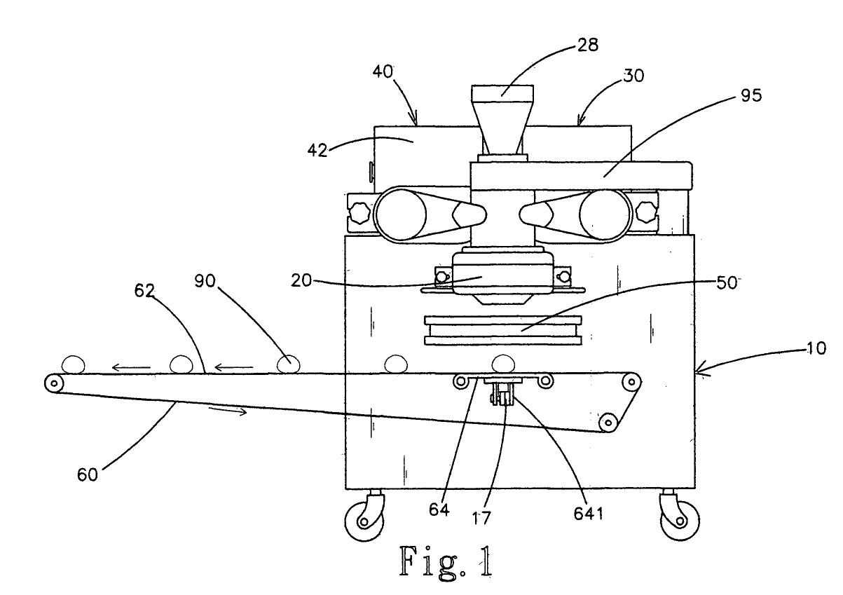

With reference to FIGS. 1, 3 and 14, the multiple layer food manufacturing apparatus 10 of the present invention includes the following elements.

A combining nozzle 20 includes an inner tube 22, an outer tube 24 enclosing the inner tube 22, and an outer sleeve 26 enclosing an outer periphery of the outer tube 24. Thereby, the combining nozzle 20 has an annular middle layer channel 23 and an annular outer channel 25. A rotary screwing rod 281 inserts through an inner channel 21 within the inner tube 22. The inner layer food material 82 passes through the inner channel 21 and then is outputted from the lower output 211. The middle layer channel 23 has a transversal inlet 231 and an outlet 232. Middle layer food material 84 is fed into the middle layer channel 23 from the transversal inlet 231 and is outputted from the lower outlet 232. The outer layer channel 25 has a longitudinal outlet 251. An outer layer food material 86 enters into the outer layer channel 25. A side wall of the outer layer channel 25 has a rotatable annular tapered ring 252 for helping the moving outer layer food material 86 so that the outer layer food material 86 can be outputted from an outlet 253 at a lower end of the outer layer channel 25. Thereby, the inner layer, middle layer, and outer layer food materials 82, 84 and 86 are output and one enclosing another so as to form a cylindrical food 88.

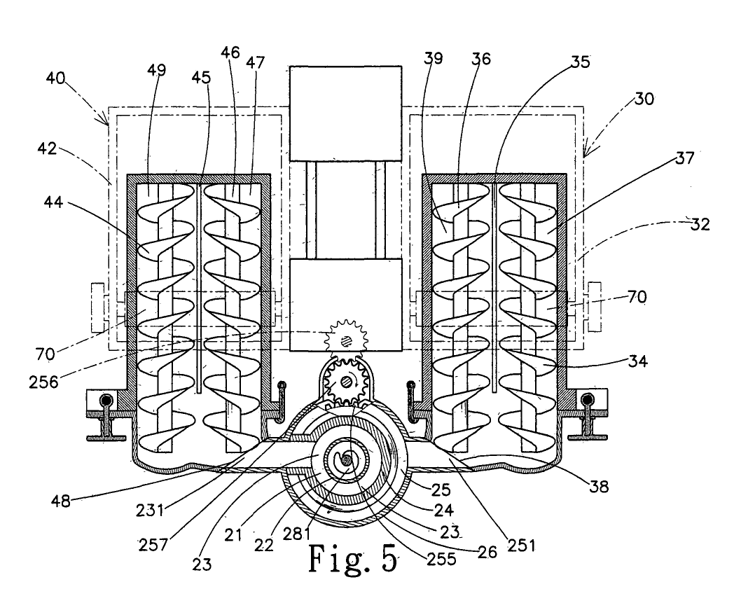

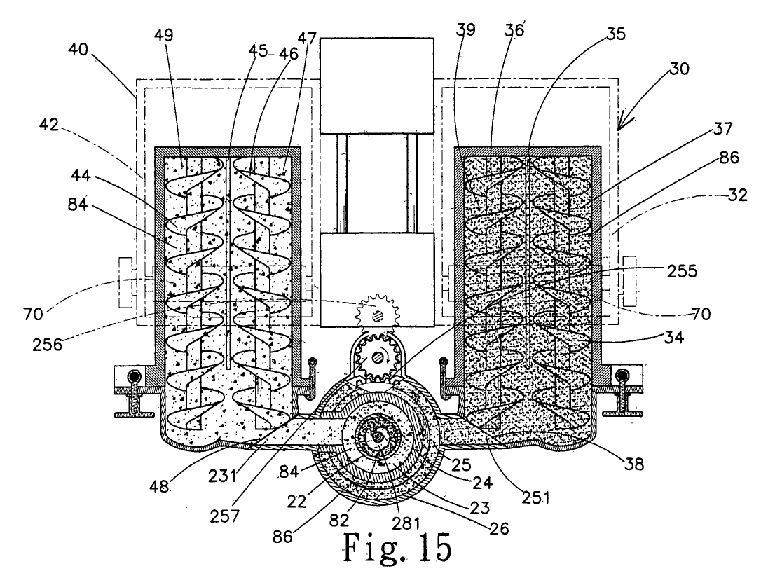

A right feeding device 30 (FIGS. 5 and 15) comprises a right collector 32 for receiving the outer layer food material 86. The right collector 32 has at least propeller, here two propellers 34 and 36 being illustrated, an outlet 38 which is communicated to and connected to the inlet 251 of the outer layer channel 25. The propellers 34, 36 serve to feed the outer layer food material 86 longitudinally to the outlet 38 and then guide the outer layer food material 86 to the outer layer channel 25.

A left feeding device 40 includes the following elements.

A left collector 42 for receiving at least one rotary propeller, herein two propellers 44, 46 being illustrated; an outlet 48 which is communicated to the transversal inlet 231 of the middle layer channel 23. The propellers 44, 46 serve to feed middle layer food material 84 longitudinally to the outlet 48 and then guide the middle layer food material 84 to the middle layer channel 23.

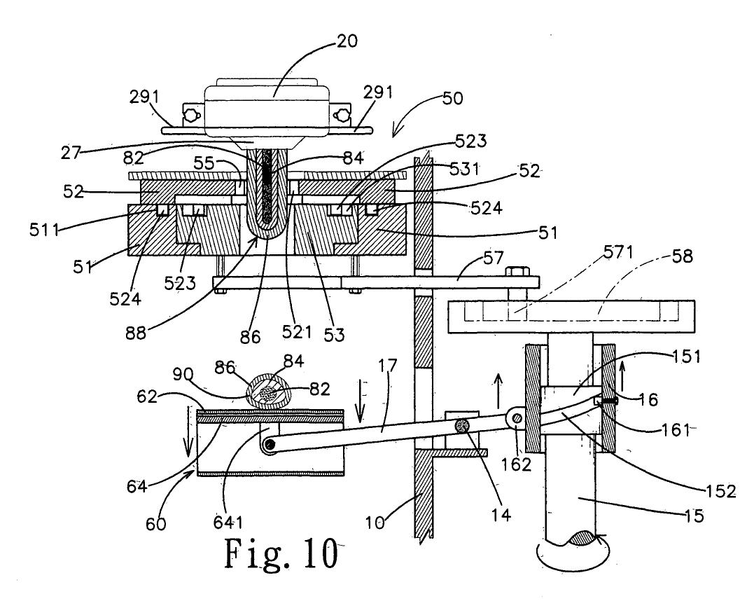

A cutter (referring to FIGS. 10, 11 and 12) includes a plurality of rotary knives 52. Each knife 52 has a cutting portion 521 at a front end thereof. The movement of the knives 52 will close or open a central opening 55. The cylindrical food 88 is outputted from the combining nozzle 20 and passes through the central opening 55 longitudinally to be cut by the cutting portions 521 so as to be formed as a ball-like food 90.

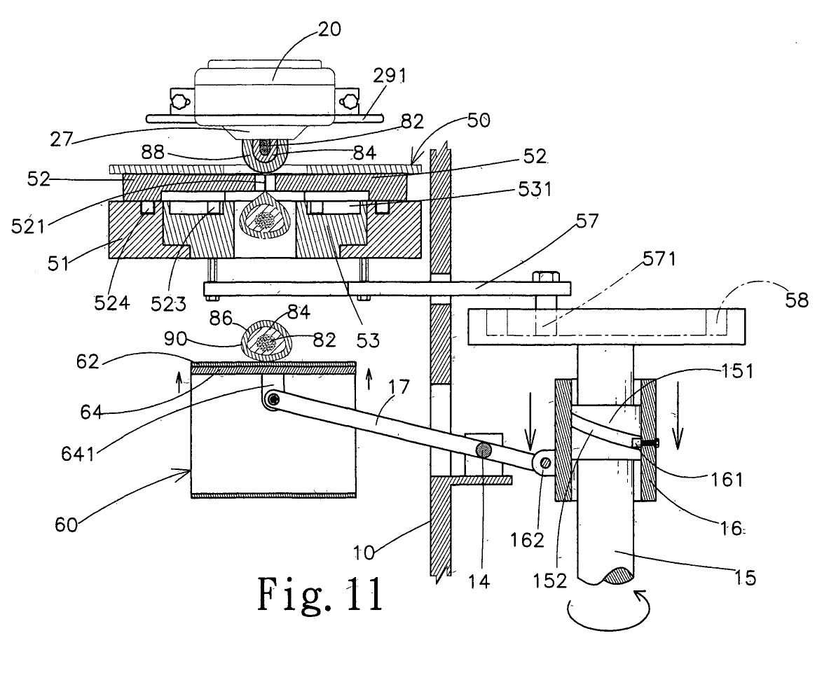

With reference to FIGS. 10, and 11, a transferring device 60 is installed below the cutter 50. The transferring device 60 has a transferring belt 62. The transferring belt 62 has a section which can is risen or restored. When a suspending transferring belt 62 is lifted, it serves for receiving the tail of the ball-like food 90. When it descends, the moving forward transferring belt 62 serves to output the ball-like food 90.

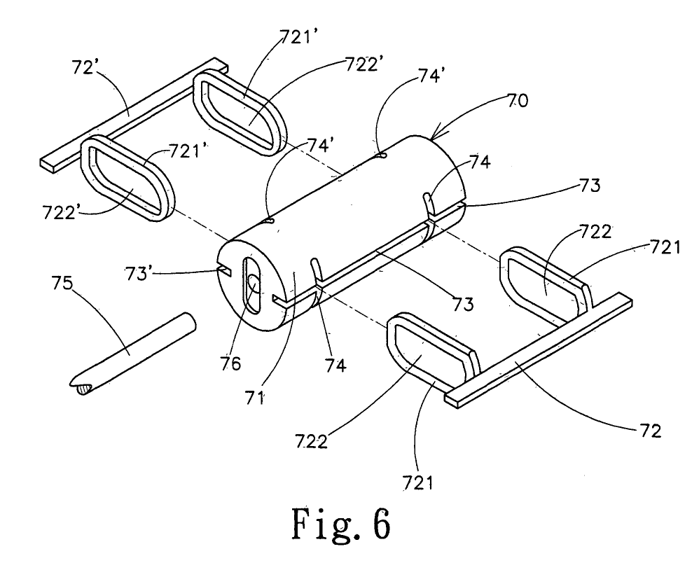

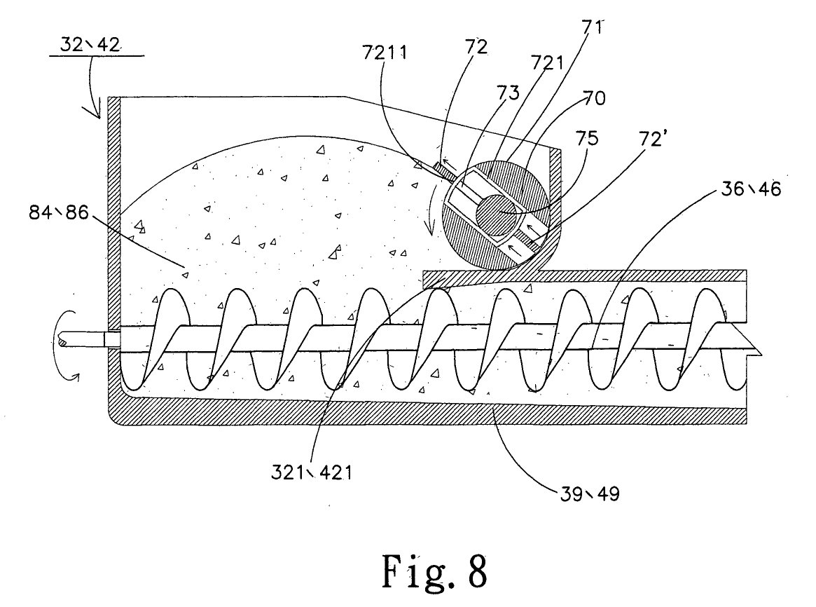

With reference to FIGS. 6, 7, 8, and 9, each of the right and left collector 32, 34 has a rotary upper roller 70. A roller surface 71 of the upper roller 70 has a plurality of axial recesses 73, 73′ and a plurality of annular recesses 74, 74′, a plurality of protruding plates 72, 72′. Each of two ends of each protruding plate 72, 72′ is installed with rings 721, 721′ which are received into the annular recesses 74, 74′. Adjacent rings 721, 721′ are alternatively arranged. The protruding plates 72, 72′ are received in the transversal recesses 73, 73′.

A driving shaft 75 passes through an axial hole 76 of the upper rollers 70 and passes through the through holes 722, 722′ of the rings 721, 721′, respectively.

An inner wall of the collectors 32, 42 below the roller surface 71 is protruded with a projection 321, 421. When the protruding plates 72, 72′ rotate to the lower extreme point, they are ejected by the projection 321, 421 to be reduced into the transversal recesses 73, 73′ of the roller surface 71.

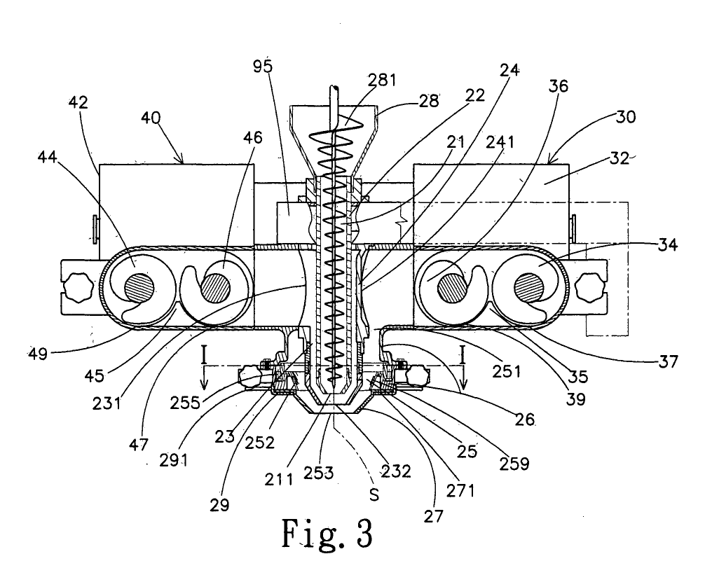

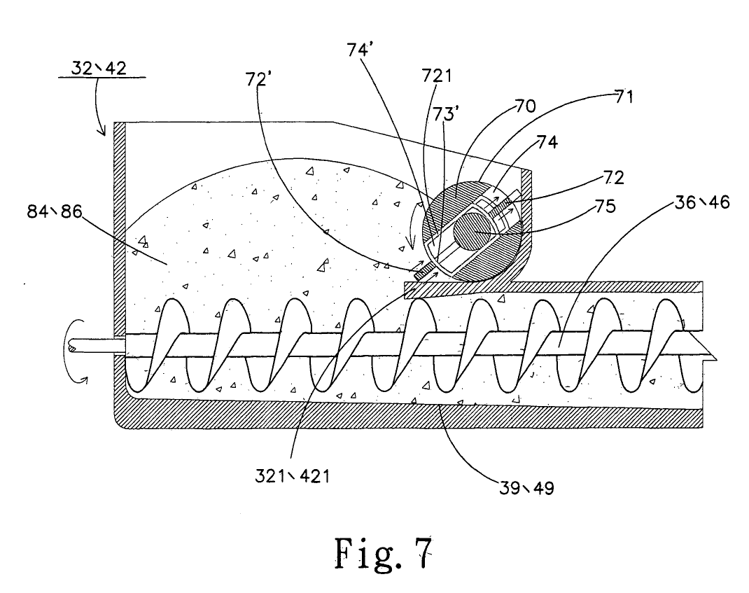

With reference to FIGS. 3 and 7, the right propellers 34, 36 are spaced by a spacer 35 and the left propellers 44, 46 are spaced by the spacer 45. Each propeller 44, 46, 34, 36 has a respective U groove 37, 39, 47, 49. Each U groove 37, 39, 47, and 49 is inclined towards the outlet, 38, 48 so as to form a level difference so that the middle layer food material 84 and outer layer food material 86 can be guided easily.

With reference to FIGS. 10, and 11, an interior of the multiple layer food manufacturing apparatus 10 is installed with a power output shaft 15. The bush 151 is installed on the power output shaft 15. A cambered trench 152 is formed on the bush 151.

A sliding sleeve 16 is skidably connected to the cambered groove 152 by a small pulley 161.

A lever 17 has one end which is movably connected to the sliding sleeve 16 and another end thereof is connected to a connecting body 641 below a top plate 64. The sliding sleeve 16 is slidably along a surface of the bush 151. Thereby, the lever 17 is rotatable around a fixing shaft 14 in the multiple layer food manufacturing apparatus 10 to swing so as to lift or descend the top plate 64 so that the transferring belt 62 attached to the top plate 64 rises or descends synchronously so as to receive the ball-like food 90 and output the ball-like food 90.

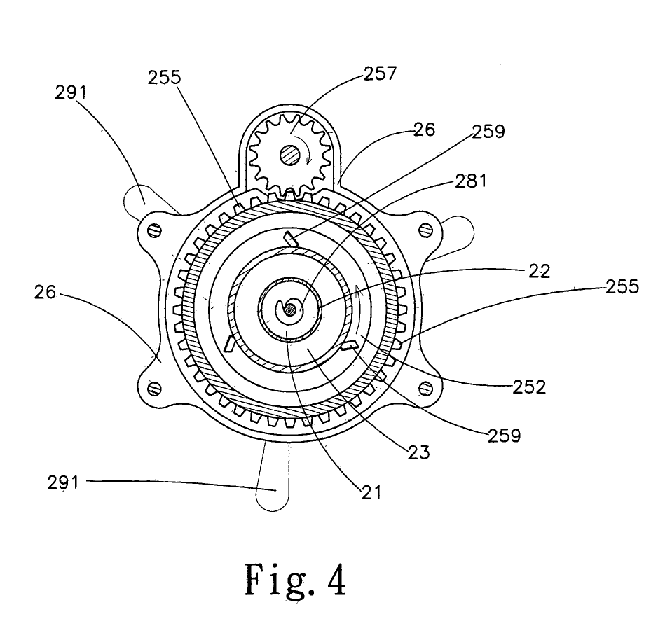

With reference to FIGS. 3 and 4, a periphery of the tapered ring 252 is connected to teeth 255. A lateral side of the outer sleeve 26 are installed with driven gear 257 which serves to drive the teeth 255 to drive the tapered ring 252 to rotate.

As shown in FIG. 3, the lower outlet 211 of the inner layer channel 21 is at an interior of the combining nozzle 20. The lower outlet 211 has a diameter smaller than the outlet 232 of the middle layer channel 23. The outlet 232 of the middle layer channel 23 is positioned slightly below the outlet 211 of the inner layer channel 21 and has a diameter smaller than the outlet 253 of the outer layer channel 25. The outlet 23 of the outer layer channel 25 is below the outlet 232 of the middle layer channel 23. The outlets 211, 232 and 253 are coaxial.

With reference to FIG. 3, the funnel 28 is connected above the inner tube 22 for receiving the inner layer food material 82.

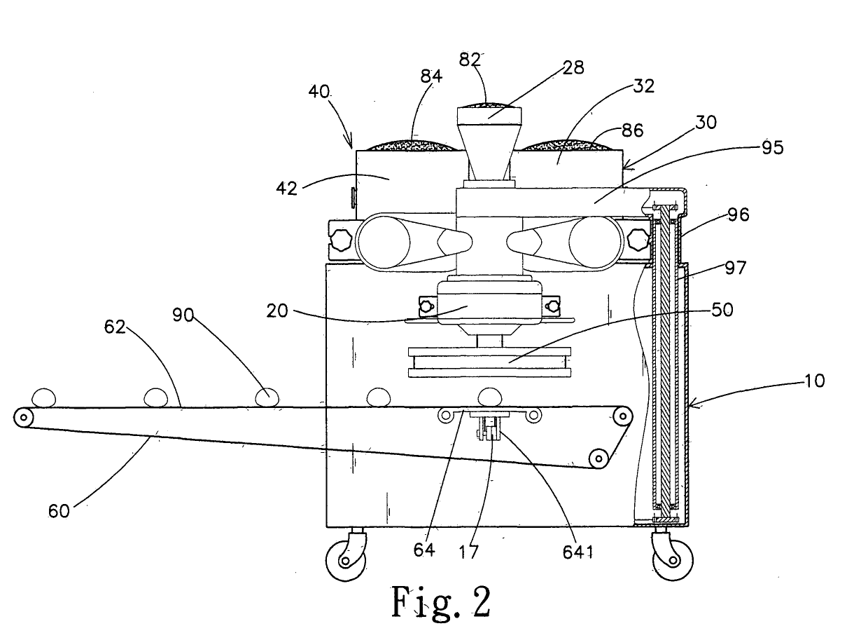

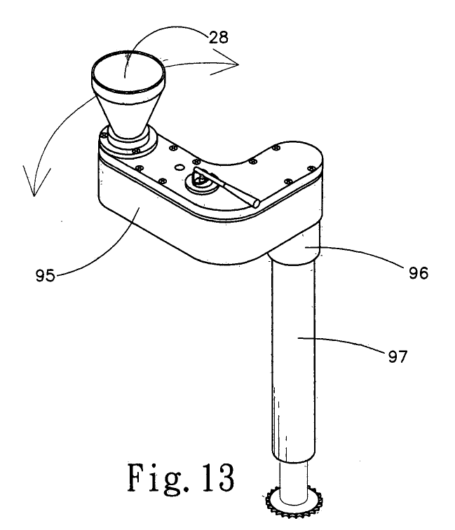

With reference to FIGS. 2 and 13, an L shape arm 95 is installed above the combining nozzle 20. A rear side of the arm 95 is movably connected to a standing inner sleeve 97 by a standing outer sleeve 96. The arm 95 is swingable around the inner sleeve 97.

With reference to FIG. 3, an outer wall of the lower outlet 253 of the outer layer channel 25 is formed as a tapered body 27.

A supporting seat 29 serves to support a lateral side 271 of the tapered body 27 and is screwed to the outer sleeve 26. An outer periphery of the supporting seat 29 is installed with a handle 291.

With reference to FIG. 3, an outer surface of the middle tube 24 is a cambered surface 241.

One application of the present invention will be described herein.

With reference to FIG. 1, the outer layer food material 86 and middle layer food material 84 are flexible dough. The outer layer food material 86 is placed in the right collector 32 and the middle layer food material 84 is placed in the left collector 32. With reference to FIGS. 6, 7, the right collector 32 and left collector 42. Each of the right and left collector 32, 34 has the rotary upper roller 70. The roller surface 71 of the upper roller 70 has two axial recesses 73, 73′ and two annular recesses 74, 74′, and two protruding plates 72, 72′. Each of two ends of each protruding plate 72, 72′ is installed with rings 721, 721′ which are received into the annular recesses 74, 74′. Adjacent rings 721, 721′ are alternatively arranged. The protruding plates 72, 72′ are received in the transversal recesses 73, 73′.

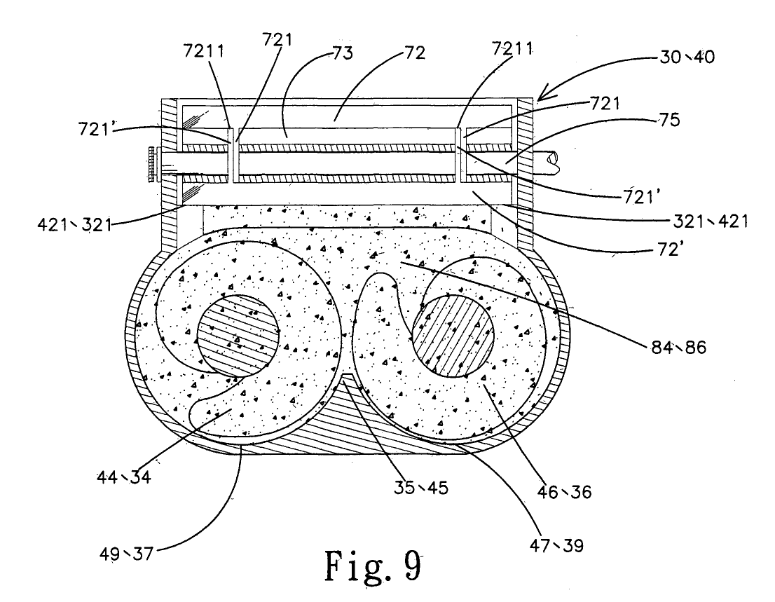

The driving shaft 75 passes through an axial hole 76 of the upper rollers 70 and passes through the through holes 722, 722′ of the rings 721, 721′, respectively. The inner wall of the collectors 32, 42 below the roller surface 71 is protruded with the projection 321, 421. When the protruding plates 72, 72′ rotate to the lower extreme point, they are ejected by the projection 321, 421 to be reduced into the transversal recesses 73, 73′ of the roller surface 71. Referring to FIG. 9, the ring 721′ of the protruding plate 72′ will eject the protruding plate 72 due to a protruding end 7211 of the protruding plate 72 so that the protruding plate 72 protrudes out of another axial recess 73. Thereby, when the protruding plate 72 rotates from an upper extreme point to the lower extreme point. The middle layer food material 84 and outer layer food material 86 are agitated to be guided to the U shape grooves 37, 39, 47, and 49 below the collectors 32, 42. The middle layer food material 84 and outer layer food material 86 are guided by the plurality of propellers 34, 36, 44, and 46. Since the bottoms of the U shape grooves 37, 39, 47, and 49 are inclined, the middle layer food material 84 can be successfully guided to the outlet 48 and then further guided to the transversal inlet 231 so that the middle layer food material 84 moves along the middle layer channel 23 (referring to FIG. 15).

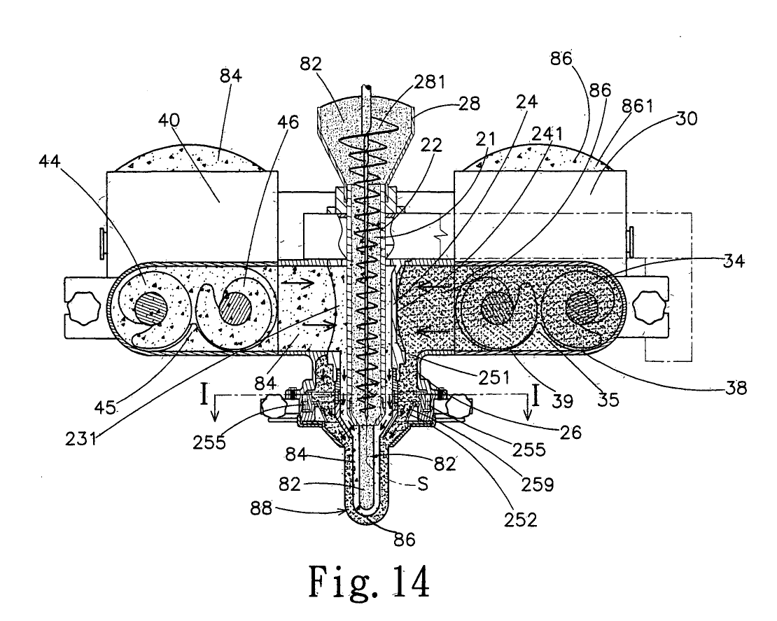

The outer layer food material 86 in the right collector 32 is successfully guided to another outlet 38 and then is further guided to the inlet 251 so that the outer layer food material 86 is guided along the outer layer channel 25, as shown in FIGS. 3 and 14. The inner layer food material 82 may be any kind of stuffing which is filled in the funnel 28 and then it is rotated by the screwing rod 281 so that the inner layer food material 82 in the inner layer channel 21 is guided longitudinally. Thereby, the inner layer food material 82, middle layer food material 84 and outer layer food material 86 are outputted from the plurality of outlets 211, 232, 253. The diameters of the outlets 211, 232, 253 have a large, a middle and a small sizes and are coaxial along a central line S. Thereby, the cylindrical food 88 outputted from the combining nozzle 20 has a inner layer food material 82, middle layer food material 84, and outer layer food material 86.

With reference to FIGS. 10, 11 and 12, the cylindrical food 88 outputted from the combining nozzle 20 passes through a central opening 55 of the cutter 50.

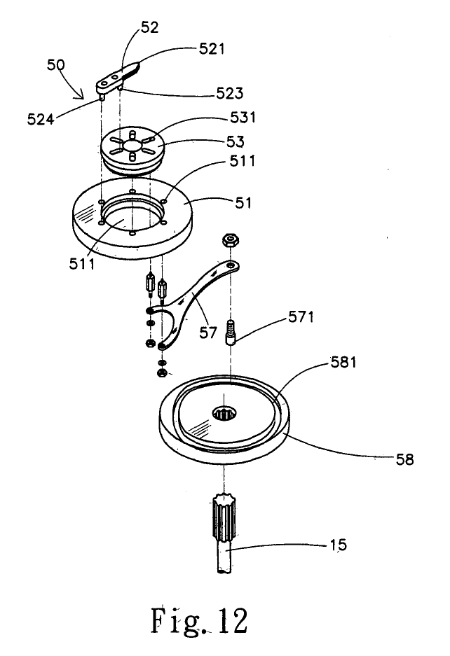

The cutter 50 includes a fixed-retaining disk 51, and a round groove 51 which is movable connected to an inner rotary disk 53. The plurality of round grooves are formed on the surface of the retaining disk 50. An inner rotary disk 53 has a plurality of long trenches 531. By the driving the a linkage 57 reciprocally, the inner rotary disk 53 rotates reciprocally on the surface of the retaining disk 51. A lower side of each knife 52 has a front axial portion 523 which is movably connected to the long trench 531 and a rear axial portion 524 which is movably connected to a respective round disk 511. Thereby, when the inner rotary disk 53 rotates reciprocally, the front axial portion 523 moves in the long trench 531 synchronously and further the rear axial portion 524 of the knife 52 also reciprocates in a finite extent. As a result, a plurality of knifes 521 serves to close the central opening 55 so as to cut the cylindrical food 88 to form with a ball-like food 90. The inner layer food material 82, middle layer food material 84, and outer layer food material 86 of the ball-like food 90 are enclosed with one another, as shown in FIG. 12. A rear end of the linkage 57 is connected to a small pulley 571.

A bottom rotary disk 58 is driven by the power output shaft 15. A surface of the bottom rotary disk 58 is a cambered recess 581. The small pulley 571 is slidably connected to the recess 581. When the bottom rotary disk 58 rotates, the linkage 57 is driven to swing reciprocally. Thereby, the inner rotary disk 53 rotates in the retaining disk 51.

The output of the ejection of the ball-like food 90 will be described herein. With reference to FIG. 9, the power output shaft 15 is positioned in the multiple layer food manufacturing apparatus 10. When it rotates, the bush 151 is driven synchronously. The small pulley 161 slides reciprocally in the cambered recess 152 so that the sliding sleeve 16 slides along the surface of the bush, as shown in FIG. 11. When the sliding sleeve 16 is at a lower extreme, the connecting end 162 of the sliding sleeve 16 will drive the linkage 17 to swing around the retaining shaft 14. Thereby, the connecting body 641 is risen to an upper extreme with the top plate 64. Meantime, the top plate 64 will eject the transferring belt 62 so that the transferring belt 62 can receive the tail of the ball-like food 90. At this moment, the transferring belt 62 do not move linearly. As shown in FIG. 10, when the sliding sleeve 16 rises to the upper extreme, the lever 17 will swing along a reverse direction so that the top plate 64 and the transferring device 60 descend to the original horizontal position. Then the transferring device 60 is actuated and the transferring belt 62 moves along a predetermined direction so as to output the ball-like food 90.

Referring to FIGS. 3, 4 and 5, the tapered ring 252 has an inner tapered surface which has a flange 259. The driven gear 257 is driven by another driving gear 256 so that the driven gear 257 drives the teeth. 255. Since the teeth 255 is connected to the tapered ring 252, the tapered ring 252 rotates for helping the outer layer food material 86 to move along the outer layer channel 25. Further, the outer layer food material 86 is guided out successfully from the outlet 253. As shown in FIGS. 2, and 13, the arm 95 can swing based on the inner sleeve 97 so as to make the combining nozzle 20 to move out with the arm 95 for clearing, repairing, and detection.

The handle 291 of the supporting seat 29 is sufficient to be held by human hands. The supporting seat 29 can be detached from the combining nozzle 20 conveniently for washing, repairing, etc. With reference to FIG. 14, the middle tube 24 can be cambered surface 241. When the outer layer food material 86 touches the cambered surface 241, it can move along the cambered surface so that the outer layer food material 86 can be guided successfully.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A multiple layer food manufacturing apparatus comprising:
a combining nozzle including an inner tube, an outer tube enclosing the inner tube, and an outer sleeve enclosing an outer periphery of the outer tube; thereby, the combining nozzle having an annular middle layer channel and an annular outer layer channel; a rotary screwing rod inserting through an inner channel within the inner tube; an inner layer food material passing through an inner layer channel in the inner tube and then being outputted from a lower output of the inner layer channel; the middle layer channel having a transversal inlet and an outlet; a middle layer food material being fed into the middle layer channel from the transversal inlet and being outputted from a lower outlet of the middle layer channel;
the outer layer channel having a longitudinal outlet; an outer layer food material entering into the outer layer channel; a side wall of the outer layer channel having a rotatable annular tapered ring for assisting the movement of the outer layer food material so that the outer layer food material is outputted from an outlet at a lower end of the outer layer channel; thereby, the inner layer, middle layer, and outer layer food materials being output; and the middle layer food material enclosing the inner layer food material, and the outer layer food material enclosing the middle layer food material so as to form a cylindrical food;
a right feeding device comprising a right collector for receiving the outer layer food material; the collector having at least one propeller, and an outlet which is communicated to and connected to the inlet of the outer layer channel; the at least one propeller serving to feed the outer layer food material longitudinally to the outlet of the right feeding device and then guide the outer layer food material to the outer layer channel;
a left feeding device comprising a left collector; the left collector having at least one rotary propeller; and an outlet which is communicated to the transversal inlet of the middle layer channel; at least one propeller serving to feed middle layer food material longitudinally to the outlet of the left feeding device and then guide the middle layer food material to the middle layer channel; and
a cutter including a plurality of rotary knives; each knife having a cutting portion at a front end thereof; the movement of the knives will close or open a central opening; the cylindrical food being outputted from the combining nozzle and passing through the central opening longitudinally to be cut by the cutting portions so as to be formed as a ball-like food.

2. The multiple layer food manufacturing apparatus as claimed in claim 1, wherein a transferring device is installed below the cutter; the transferring device has a transferring belt; the transferring belt has a horizontal section which can is risen or restored; when a suspending transferring belt is lifted, it serves for receiving the tail of the ball-like food; when it descends, the moving forward transferring belt serves to output the ball-like food.

3. The multiple layer food manufacturing apparatus as claimed in claim 1, wherein each of the right and left collector has a rotary upper roller; a roller surface of each upper roller has a plurality of axial recesses and a plurality of annular recesses, and a plurality of protruding plates; each of two ends of each protruding plate is installed with rings which are received into the annular recesses; adjacent rings are alternatively arranged; the protruding plates are received in the transversal recesses;
a driving shaft passes through an axial hole of the upper rollers and passes through the through holes of the rings, respectively;
wherein an inner wall of each collectors below the roller surface is protruded with a projection; when the protruding plates rotate to the lower extreme point, they are ejected by the projection to be reduced into the transversal recesses of the roller surface.

4. The multiple layer food manufacturing apparatus as claimed in claim 1, wherein there are at least two right propellers and at least two left propellers; the right propellers are spaced by a spacer and the left propellers are spaced by the spacer; each propeller has a respective U groove; each U groove is inclined towards the outlet, so as to form a level difference so that the middle layer food material and outer layer food material are guided easily.

5. The multiple layer food manufacturing apparatus as claimed in claim 1, wherein an interior of the multiple layer food manufacturing apparatus is installed with a power output shaft; the bush is installed on the power output shaft; a cambered trench is formed on the bush;
a sliding sleeve is skidably connected to the cambered groove by a small pulley; and
a lever has one end which is movably connected to the sliding sleeve and another end thereof is connected to a connecting body below a top plate; the sliding sleeve is slidably along a surface of the bush; thereby, the lever is rotatable around a fixing shaft in the multiple layer food manufacturing apparatus to swing so as to lift or descend the top plate so that the transferring belt attached to the top plate rises or descended synchronously so as to receive the ball-like food and output the ball-like food.

6. The multiple layer food manufacturing apparatus as claimed in claim 1, wherein a periphery of the tapered ring is connected to the teeth; a lateral side of the outer sleeve are installed with driven gear which serves to drive the teeth to drive the tapered ring to rotate.

7. The multiple layer food manufacturing apparatus as claimed in claim 1, wherein the lower outlet of the inner layer channel is at an interior of the combining nozzle; the lower outlet has a diameter smaller than the outlet of the middle layer channel; the outlet of the middle layer channel is positioned slightly below the outlet of the inner layer channel and has a diameter smaller than the outlet of the outer layer channel the outlet of the outer layer channel is below the outlet of the middle layer channel; the outlets of the inner layer channel, middle layer channel, and outer layer channel are coaxial.

8. The multiple layer food manufacturing apparatus as claimed in claim 1, wherein a funnel is connected above the inner tube for receiving the inner layer food material.

9. The multiple layer food manufacturing apparatus as claimed in claim 1, wherein an L shape arm is installed above the combining nozzle; a rear side of the arm is movably connected to a standing inner sleeve by a standing outer sleeve; the arm is swingable around the inner sleeve.

10. The multiple layer food manufacturing apparatus as claimed in claim 1, wherein an outer wall of the lower outlet of the outer layer channel is formed as a tapered body;
a supporting seat serves to support a lateral side of the tapered body and is screwed to the outer sleeve; an outer periphery of the supporting seat is installed with a handle,

11. The multiple layer food manufacturing apparatus as claimed in claim 10, wherein an outer surface of the middle tube is a cambered surface.
